(19) United States
(12) Patent Application Publication
(10) Pub. No.: US 2025/0243370 A1
(43) Pub. Date: Jul. 31, 2025

(54) POLYDIMETHYLSILOXANE SUPERAMPHIPHOBIC COATING, PREPARATION METHOD THEREOF, AND APPLICATION THEREOF

(71) Applicant: BEIJING TSD SEMICONDUCTOR CO., LTD., Beijing (CN)

(72) Inventors: Fang XUE, Beijing (CN); Jile JIANG, Beijing (CN)

(73) Assignee: BEIJING TSD SEMICONDUCTOR CO., LTD., Beijing (CN)

(21) Appl. No.: 19/067,069

(22) Filed: Feb. 28, 2025

(30) Foreign Application Priority Data
Sep. 4, 2023 (CN) 202311129901.6
Dec. 5, 2023 (CN) 202311648286.X

(51) Int. Cl. C09D 5/16; C09D 4/00; C09D 7/20; C09D 7/40; C09D 7/62; C09D 133/16; C09D 175/04

(52) U.S. Cl. CPC C09D 5/1675; C09D 4/00; C09D 5/1618; C09D 7/20; C09D 7/62; C09D 7/67; C09D 7/69; C09D 133/16; C09D 175/04

(57) ABSTRACT

Disclosed is a polydimethylsiloxane superamphiphobic coating, and a preparation method and application thereof. The polydimethylsiloxane superamphiphobic coating includes the following raw materials: hydroxyl polydimethylsiloxane, a sulfhydryl compound, fluorinated acrylate, a curing agent, and an initiator. The preparation method of the polydimethylsiloxane superamphiphobic coating includes the following steps: mixing the hydroxyl polydimethylsiloxane, the sulfhydryl compound, the fluorinated acrylate, the initiator, and a solvent to obtain a mixed solution; performing irradiation on the mixed solution; adding the curing agent to obtain a coating solution; applying the coating solution on a surface of a substrate; and allowing for curing to obtain the polydimethylsiloxane superamphiphobic coating.

### CROSS-REFERENCE TO RELATED APPLICATIONS

The present invention claims priority to Chinese Patent Application No. CN202311129901.6 titled “POLYDIMETHYLSILOXANE SUPERAMPHIPHOBIC COATING, AND PREPARATION METHOD AND APPLICATION THEREOF” and filed on Sep. 4, 2023, and Chinese Patent Application No. 202311648286.X titled “PREPARATION METHOD OF SUPERAMPHIPHOBIC COATING, AND SUPERAMPHIPHOBIC COATING PREPARED THEREFROM AND APPLICATION THEREOF” and filed on Dec. 5, 2023.

### TECHNICAL FIELD

The present invention relates to the field of self-cleaning materials, particularly to a polydimethylsiloxane superamphiphobic coating, as well as a preparation method and application thereof.

### BACKGROUND

Chemical Mechanical Planarization (CMP), as one of the most crucial techniques for achieving multilevel metallization and incorporation of gate and channel materials in an integrated circuit (IC) manufacturing process, is an indispensable planarization technology in semiconductor manufacturing. However, a slurry used in CMP contains a certain quantity of grinding nanoparticles (such as SiO₂ and CeO₂). During CMP, the mechanical grinding effect heats the slurry, causing the water therein to evaporate. This increases the concentration of the grinding nanoparticles, leading to local oversaturation. Additionally, heating also accelerates the movement of colloidal particles, causing the nanoparticles to agglomerate and adhere to the surface of a planarization device to form white crystal substances that are difficult to clean, and thus seriously affecting the subsequent processes and production. Furthermore, since the planarization device is made of metal materials, the long-term use of the slurry can also cause corrosion. However, there is no clear solution to the problem of nanoparticle agglomeration in a slurry system in the prior art. Therefore, it has become an effective solution to apply a superamphiphobic coating with both anti-corrosion and self-cleaning properties on the planarization device.

Polydimethylsiloxane (PDMS), as a type of polymer with low surface energy and good mechanical properties, thermal stability, and chemical stability, can be used as an alternative material for superamphiphobic anti-corrosion coatings. However, the lack of oleophobicity and strong adsorption of non-polar substances hinders the PDMS's application in the field of superamphiphobic coatings. Therefore, it is necessary to perform surface modification on the PDMS.

Currently, methods for performing surface modification on the PDMS include plasma treatment, ultraviolet (UV) irradiation, ozone irradiation, and surfactant treatment, while plasma treatment can only be a temporary treatment; UV irradiation and ozone irradiation require strict environmental conditions and long reaction times; and surfactants can be combined with a PDMS surface to reduce hydrophobicity and bonding strength, and affect the mechanical properties of the PDMS.

Therefore, there is an urgent need in the prior art for a superamphiphobic coating with a good superamphiphobic effect, strong durability, and a simple preparation method to keep the surface of the planarization device clean.

### SUMMARY

In order to solve the problem existing in the prior art, the present invention provides a polydimethylsiloxane superamphiphobic coating, and a preparation method and application thereof.

In a first aspect, the present invention provides a polydimethylsiloxane superamphiphobic coating, including the following raw materials: hydroxyl polydimethylsiloxane, a sulfhydryl compound, fluorinated acrylate, a curing agent, and an initiator.

Specifically, the hydroxyl polydimethylsiloxane is hydroxyl-terminated polydimethylsiloxane with a viscosity of 90-100 cp (25° C.) and a hydroxyl content of (1.03±0.03) wt %.

In a first embodiment according to the first aspect of the present invention, a mass ratio of the hydroxyl polydimethylsiloxane, the sulfhydryl compound, and the curing agent is (1-3):1:(0.1-0.4); and a mass ratio of the sulfhydryl compound, the fluorinated acrylate, and the initiator is 1:(0.6-3):(0.01-0.3).

In an embodiment of the present invention, the raw materials for preparing the polydimethylsiloxane superamphiphobic coating further include filler particles, and a mass ratio of the hydroxyl polydimethylsiloxane to the filler particles is 1:(0.5-2.5).

In an embodiment of the present invention, the filler particles include micron-sized particles and nano-sized particles;

the micron-sized particles have a diameter of 2-10 μm, the nano-sized particles have a diameter of 10-30 nm, and a mass ratio of the micron-sized particles to the nano-sized particles is 1: (1-5); and

the micron-sized particles and the nano-sized particles are each independently selected from one or more of hydrophobically modified SiO₂, TiO₂, Al₂O₃, polytetrafluoroethylene, fluorinated graphite, and hollow glass microspheres.

Specifically, in the present invention, the hydrophobically modified SiO₂ is prepared through the following steps: placing SiO₂ in a mixed solution, where the mixed solution includes 95% ethanol by volume and 5% deionized water by volume; adding fluorosiloxane to the mixed solution; and adjusting the pH value of the mixed solution to be acidulous or alkalescent (pH=5 or pH=9), thereby achieving hydrophobical modification of SiO₂ through fluorosiloxane. A mass ratio of SiO₂ to fluorosiloxane is 1:(0.15-0.2).

Specifically, a mass ratio of SiO₂ to fluorosiloxane is 1:0.15.

Specifically, the pH value of the mixed solution is adjusted to be pH=5.

In an embodiment of the present invention, the polydimethylsiloxane superamphiphobic coating has a water contact angle of 132° to 154° and an oil contact angle of 114° to 129°.

In a second embodiment according to the first aspect of the present invention, on the basis of a mass of the hydroxyl polydimethylsiloxane being 100%, a mass of the sulfhydryl compound is 1%-10%, a mass of the fluorinated acrylate is 2%-20%, a mass of the initiator is 0.01%-1%, and a mass of the curing agent is 10%-30%.

Preferably, on the basis of a mass of the hydroxyl polydimethylsiloxane being 100%, a mass of the sulfhydryl compound is 3%-7%, a mass of the fluorinated acrylate is 5%-10%, a mass of the initiator is 0.05-0.5%, and a mass of the curing agent is 15%-25%.

In an embodiment of the present invention, the raw materials for preparing the polydimethylsiloxane superamphiphobic coating further include filler particles, and a mass ratio of the hydroxyl polydimethylsiloxane to the filler particles is 1:(0.1-1).

In an embodiment of the present invention, the filler particles include micron-sized particles and nano-sized particles;
specifically, the micron-sized particles have a particle size of 5-15 μm, the nano-sized particles have a particle size of 10-30 nm, and a mass ratio of the micron-sized particles to the nano-sized particles is 1: (1-5); and
specifically, the micron-sized particles and the nano-sized particles are each independently selected from one or more of hydrophobically modified SiO₂, TiO₂, Al₂O₃, polytetrafluoroethylene, fluorinated graphite, and hollow glass microspheres.

Specifically, in the present invention, the hydrophobically modified SiO₂ is prepared through the following steps: placing SiO₂ in a mixed solution, where the mixed solution includes 95% ethanol by volume and 5% deionized water by volume; adding fluorosiloxane to the mixed solution; and adjusting the pH value of the mixed solution to be acidulous or alkalescent (pH=5 or pH=9), thereby achieving hydrophobical modification of SiO₂ through fluorosiloxane. A mass ratio of SiO₂ to fluorosiloxane is 1:(0.15-0.2).

Specifically, a mass ratio of SiO₂ to fluorosiloxane is 1:0.15.

Specifically, the pH value of the mixed solution is adjusted to be pH=5.

In an embodiment of the present invention, the superamphiphobic coating prepared in the second embodiment according to the first aspect of the present invention is subjected to a property test.

The polydimethylsiloxane superamphiphobic coating has a water contact angle of 145° to 159° and an oil contact angle of 134° to 149°.

The abrasion resistance of the polydimethylsiloxane superamphiphobic coating is tested by a counterweight shifting method to be 122 g to 200 g.

The hardness of the polydimethylsiloxane superamphiphobic coating is tested by a pencil hardness method to be 4H.

The adhesion of the polydimethylsiloxane superamphiphobic coating is tested according to GB/T 9286-1998 to be 4B.

In a second aspect, the present invention provides a preparation method of the polydimethylsiloxane superamphiphobic coating provided in the first embodiment according to the first aspect of the present invention, including the following steps:
(1) preparing a mixed solution I using the hydroxyl polydimethylsiloxane, the sulfhydryl compound, the curing agent, and a solvent I, enabling the hydroxyl polydimethylsiloxane to react with the sulfhydryl compound in the mixed solution I, applying the mixed solution I on a surface of a substrate, and allowing for curing, where the mixed solution I can be applied by spin coating, spray coating, dip coating, or drip coating; and
(2) preparing a mixed solution II using the fluorinated acrylate, the initiator, and a solvent II, immersing the substrate cured in the step (1) in the mixed solution II, performing irradiation, enabling the sulfhydryl compound to react with the fluorinated acrylate, and allowing for aging to obtain the polydimethylsiloxane superamphiphobic coating.

A condensation reaction between hydroxyl and sulfhydryl groups in the hydroxyl-terminated polydimethylsiloxane is used for introducing the sulfhydryl groups into the polydimethylsiloxane coating, and then the curing agent is added for cross-linking and curing. After curing is complete, the remaining sulfhydryl groups on the film surface are further used as reactive sites, and through a thiol-double bond click reaction, the fluorinated acrylate is introduced to the film surface to achieve buildup of low surface energy, so that the PDMS coating has superamphiphobic properties of hydrophobicity and oleophobicity.

In an embodiment of the present invention, the raw materials for preparing the polydimethylsiloxane superamphiphobic coating further include filler particles, and the filler particles include micron-sized particles and nano-sized particles.

The micron-sized particles have a diameter of 2-10 μm, and the nano-sized particles have a diameter of 10-30 nm.

The micron-sized particles and the nano-sized particles are each independently selected from one or more of hydrophobically modified SiO₂, TiO₂, Al₂O₃, polytetrafluoroethylene, fluorinated graphite, and hollow glass microspheres.

In the step (1), the mixed solution I is prepared using the hydroxyl polydimethylsiloxane, the sulfhydryl compound, the filler particles, the curing agent, and the solvent I. The added filler particles can simulate a papillary structure on the surface of a lotus leaf to construct a fine micro-nano surface secondary structure, thereby increasing the water and oil contact angles of the coating, while enhancing the mechanical properties thereof; and
the filler particles account for 5%-20% of the mixed solution I by weight.

In an embodiment of the present invention, in the step (1), before applying the mixed solution I on the surface of the substrate, the preparation method further includes pre-treating the substrate, where the pre-treating includes rinsing the substrate to make the surface of the substrate clean.

Specifically, acetone, ethanol, and deionized water are used for rinsing the substrate in the pre-treating process of the present invention.

In an embodiment of the present invention, the hydroxyl polydimethylsiloxane accounts for 10%-20% of the solvent I by weight.

In an embodiment of the present invention, the fluorinated acrylate accounts for 20%-30% of the mixed solution II by weight.

In an embodiment of the present invention, the initiator accounts for 0.1%-3% of the mixed solution II by weight.

In an embodiment of the present invention, in the step (1), the mixed solution I is stirred and defoamed, and then applied on the surface of the substrate.

In an embodiment of the present invention, in the step (1), a curing condition includes curing for 8-12 h.

In an embodiment of the present invention, in the step (2), an irradiation condition includes UV irradiation with a wavelength of 300-380 nm, a power of 8-12 W, and an irradiation time of 2-8 h. Under the action of irradiation, a reaction between the sulfhydryl groups and the fluorinated acrylate can be initiated.

In the step (2), an aging condition includes aging at a temperature of 40-60° C. for 1-5 h. During the aging process, the reaction between the sulfhydryl groups and the fluorinated acrylate is more sufficient.

In an embodiment of the present invention, the sulfhydryl compound includes at least one or more of pentaerythritol tetrakis(3-mercaptopropionate), dipentaerythritol hexakis (3-mercaptopropionate), trimethylolpropane tris(3-mercaptopropionate), 4-arm-PEG-SH, 3-mercapto-1-propanol, 1,4-butanediol bis(thioglycolate), bis(2-mercaptoethyl) adipate, diisopropyl 2,3-dimercaptosuccinate, 1,4-butanedithiol, and glycol dimercaptoacetate.

Preferably, the sulfhydryl compound is pentaerythritol tetrakis(3-mercaptopropionate).

In an embodiment of the present invention, the curing agent includes at least one or more of isocyanate, acetic acid, butylenediamine, butanone oxime, and 2-butanone oxime.

Specifically, isocyanate is poly(hexamethylene diisocyanate).

In an embodiment of the present invention, the fluorinated acrylate includes at least one or more of 1H,1H,2H,2H-heptadecafluorodecyl acrylate, 1H, 1H,2H,2H-perfluorooctyl methacrylate, 2-(perfluorohexyl)ethyl methacrylate, 2-(perfluorooctyl)ethyl methacrylate, 2-(perfluoroalkyl)ethyl methacrylate, 1H,1H,2H,2H-perfluorooctyl acrylate, eicosafluoroundecyl acrylate, and 2-(perfluorobutyl)ethyl methacrylate.

Preferably, the fluorinated acrylate is 1H, 1H,2H,2H-heptadecafluorodecyl acrylate.

In an embodiment of the present invention, the initiator includes at least one or more of 2,2-dimethoxy-2-phenylacetophenone, benzophenone, and a photoinitiator 184.

In an embodiment of the present invention, the substrate includes at least one of glass sheets, steel, wood, paper, marble, and cotton.

In an embodiment of the present invention, the solvent I is selected from one or more of dichloromethane, chloroform, N, N-dimethylformamide, tetrahydrofuran, acetone, and hexane.

In an embodiment of the present invention, the solvent II is selected from one or more of acetone, anhydrous ethanol, isopropanol, n-butanol, dichloromethane, hexane, toluene, tetrahydrofuran, ethyl acetate, and N, N-dimethylformamide.

The preparation method of the polydimethylsiloxane superamphiphobic coating provided in the second embodiment according to the first aspect of the present invention includes the following steps:
mixing the hydroxyl polydimethylsiloxane, the sulfhydryl compound, the fluorinated acrylate, the initiator, and a solvent to obtain a mixed solution; performing irradiation on the mixed solution; adding the curing agent to obtain a coating solution; applying the coating solution on a surface of a substrate; and allowing for curing to obtain the polydimethylsiloxane superamphiphobic coating. The coating solution can be applied by spin coating, spray coating, dip coating, or drip coating.

In the preparation method provided by the present invention, the hydroxyl polydimethylsiloxane is mixed with the sulfhydryl compound and the fluorinated acrylate in the solvent; after sufficient reaction, the curing agent is added to obtain the coating solution; the coating solution is applied on the surface of the substrate by spray coating; and after complete curing, the uniform and stable superamphiphobic coating is obtained.

The hydroxyl-terminated polydimethylsiloxane and the sulfhydryl compound are grafted to obtain an organic resin intermediate (sulfhydryl-grafted siloxane resin chain segments are obtained through a condensation reaction between hydroxyl and sulfhydryl groups), and then the fluorinated acrylate having low surface energy is grafted onto the terminal of a siloxane resin chain in a chemical bonding manner through a light-induced thiol-ene click reaction.

In the preparation method of the present invention, the sulfhydryl compound, as an intermediate chain segment of a polymer, can react with both the hydroxyl polydimethylsiloxane and the fluorinated acrylate. The curing agent is added after the sulfhydryl compound, the hydroxyl polydimethylsiloxane, and the fluorinated acrylate sufficiently react, so that it is not limited by the time when the curing agent is added. The fluorinated acrylate is uniformly present in the coating in the chemical bonding manner, thus ensuring the property stability of the coating.

In an embodiment of the present invention, the raw materials for preparing the polydimethylsiloxane superamphiphobic coating further include filler particles.

The preparation method further includes: adding the filler particles after the step of performing irradiation on the mixed solution and before the step of adding the curing agent; and the filler particles account for 1%-3% of the mixed solution by weight.

The added filler particles can simulate a papillary structure on the surface of a lotus leaf to construct a fine micro-nano surface secondary structure, thereby increasing the water and oil contact angles of the coating, while enhancing the mechanical properties thereof.

In an embodiment of the present invention, before applying the mixed solution I on the surface of the substrate, the preparation method further includes pre-treating the substrate, where the pre-treating includes rinsing the substrate to make the surface of the substrate clean. Specifically, acetone, ethanol, and deionized water are used for rinsing the substrate in the pre-treating process of the present invention.

In an embodiment of the present invention, the hydroxyl polydimethylsiloxane accounts for 9%-20% of the solvent by weight.

In an embodiment of the present invention, the sulfhydryl compound accounts for 0.4%-1% of the solvent by weight.

In an embodiment of the present invention, the fluorinated acrylate accounts for 0.5%-2% of the solvent by weight.

In an embodiment of the present invention, the preparation method further includes: after the step of adding the curing agent, performing ultrasound treatment and defoaming to obtain the coating solution, and applying the coating solution on the surface of the substrate.

In an embodiment of the present invention, an irradiation condition includes UV irradiation with a wavelength of 300-380 nm, a power of 8-12 W, and an irradiation time of 2-8 h.

Specifically, the mixed solution is irradiated while being stirred at a rotating speed of 500-1000 rpm.

In an embodiment of the present invention, a curing condition includes curing at room temperature for 8-12 h;
in an embodiment of the present invention, a curing condition includes curing at 50° C. for 3-5 h; and
in an embodiment of the present invention, a curing condition includes curing at 80° C. for 30 min to 1 h.

Among the raw materials used in the present invention, the sulfhydryl compound includes at least one or more of pentaerythritol tetrakis(3-mercaptopropionate), dipentaerythritol hexakis (3-mercaptopropionate), trimethylolpropane tris(3-mercaptopropionate), 4-arm-PEG-SH, 3-mercapto-1-propanol, 1,4-butanediol bis(thioglycolate), bis(2-mercaptoethyl) adipate, diisopropyl 2,3-dimercaptosuccinate, 1,4-butanedithiol, and glycol dimercaptoacetate.

Preferably, the sulfhydryl compound is pentaerythritol tetrakis(3-mercaptopropionate).

In an embodiment of the present invention, the curing agent includes at least one or more of isocyanate, acetic acid, butylenediamine, butanone oxime, and 2-butanone oxime.

Specifically, isocyanate is poly(hexamethylene diisocyanate).

In an embodiment of the present invention, the fluorinated acrylate includes at least one or more of 1H,1H,2H,2H-heptadecafluorodecyl acrylate, 1H, 1H,2H,2H-perfluorooctyl methacrylate, 2-(perfluorohexyl)ethyl methacrylate, 2-(perfluorooctyl)ethyl methacrylate, 2-(perfluoroalkyl)ethyl methacrylate, 1H, 1H,2H,2H-perfluorooctyl acrylate, eicosafluoroundecyl acrylate, and 2-(perfluorobutyl)ethyl methacrylate.

Preferably, the fluorinated acrylate is 1H, 1H,2H,2H-heptadecafluorodecyl acrylate.

In an embodiment of the present invention, the initiator includes at least one or more of 2,2-dimethoxy-2-phenylacetophenone, benzophenone, and a photoinitiator 184.

In an embodiment of the present invention, the substrate includes at least one of glass sheets, steel, wood, paper, marble, and cotton.

In an embodiment of the present invention, the solvent I is selected from one or more of dichloromethane, chloroform, N, N-dimethylformamide, tetrahydrofuran, acetone, and hexane.

In an embodiment of the present invention, the solvent II is selected from one or more of acetone, anhydrous ethanol, isopropanol, n-butanol, dichloromethane, hexane, toluene, tetrahydrofuran, ethyl acetate, and N, N-dimethylformamide.

In a third aspect, the present invention provides an application of the polydimethylsiloxane superamphiphobic coating provided in the first aspect of the present invention or the polydimethylsiloxane superamphiphobic coating prepared by the preparation method provided in the second aspect of the present invention in cleaning of a planarization device during a chemical mechanical planarization process.

The superamphiphobic coating provided in the first embodiment according to the first aspect of the present invention and the superamphiphobic coating prepared in the second aspect by the preparation method of the superamphiphobic coating provided in the first embodiment according to the first aspect of the present invention have the following beneficial effects.
(1) The coating prepared by the present invention has a water contact angle greater than 132° and an oil contact angle greater than 114°, demonstrating that the coating has strong superamphiphobic properties, so that after being applied on a planarization device, the coating can prevent grinding nano-particles in the slurry from being adhered to the surface of the planarization device to a large extent to keep the surface of the planarization device clean.
(2) The in-situ self-assembly of the fluorinated acrylate in the present invention is based on the thiol-ene click reaction, which is simple and efficient with a high conversion rate, and the prepared polydimethylsiloxane superamphiphobic coating has large water and oil contact angles.
(3) The polydimethylsiloxane superamphiphobic coating prepared by the present invention has strong chemical corrosion resistance, adhesion, and abrasion resistance, so that it can be applied in chemical mechanical polishing (CMP) or other harsh application environments.
(4) The polydimethylsiloxane superamphiphobic coating prepared by the present invention also has good thermal stability, so that it is suitable for high working temperatures.
(5) In the process of preparing the coating in the present invention, the added filler particles in the coating can simulate a papillary structure on the surface of a lotus leaf to construct a fine micro-nano surface secondary structure, thereby increasing the water and oil contact angles of the coating. Optionally, the filler particles in the present invention may be hydrophobically modified SiO₂ particles, polytetrafluoroethylene particles, or other particles, and a change in the type of nanoparticles has little impact on the hydrophobic and oleophobic properties of the coating.
(6) The hydroxyl polydimethylsiloxane used in the present invention can be well adhered to the surface of the substrate because of containing hydroxyl groups, so that before the prepared coating is applied on the surface of the substrate, the surface of the substrate does not need to be pretreated with a pretreating agent.
(7) The modified polydimethylsiloxane superamphiphobic coating provided in the present invention has a wide range of application and is expected to be used in the fields of equipment anti-corrosion, oil-water separation, clothing, electronic product protection, etc.

The superamphiphobic coating provided in the second embodiment according to the first aspect of the present invention and the superamphiphobic coating prepared in the second aspect by the preparation method of the superamphiphobic coating provided in the second embodiment according to the first aspect of the present invention have the following beneficial effects.
(1) The coating prepared by the present invention has a water contact angle of 145° to 159° and an oil contact angle of 134° to 149°. The coating has strong superamphiphobic properties, so that after being applied on the planarization device, the coating can prevent grinding nano-particles in the slurry from being adhered to the surface of the planarization device to a large extent to keep the surface of the planarization device clean.
(2) In the present invention, the hydroxyl polydimethylsiloxane, the sulfhydryl compound, and the fluorinated acrylate are subjected to graft polymerization by a one-step method to obtain siloxane polymer chain segments modified with long fluorocarbon chain groups at the terminal. The sulfhydryl compound can react sufficiently with the hydroxyl polydimethylsiloxane and the fluorinated acrylate at the same time, and the amount of fluorine introduced into the coating is neither limited by the quantity of sulfhydryl groups grated to the hydroxyl groups nor limited by the reaction time of the hydroxyl polydimethylsiloxane and the sulfhydryl compound. In addition, a reversible thiol-ene click reaction exists between the sulfhydryl compound and the fluorinated acrylate, thereby enabling the superamphiphobic coating with a certain self-healing property.
(3) The hydroxyl groups in the hydroxy polydimethylsiloxane used in the present invention have strong polarity, so that they are conductive for the hydroxyl polydimethylsiloxane to bond with the substrate material, thereby ensuring that the coating has strong adhesion and before the coating is applied on the surface of the substrate, the surface of the substrate does not need to be pretreated with a pretreating agent. Moreover, after being grafted with the fluorinated acrylate, the hydroxyl polydimethylsiloxane has lower surface energy, so that the hydroxyl polydimethylsiloxane tends to move to the surface of the coating and enables the coating with excellent hydrophobic and oleophobic properties.
(4) The polydimethylsiloxane superamphiphobic coating prepared by the present invention has strong chemical corrosion resistance, adhesion, and abrasion resistance, so that it can be applied in chemical mechanical polishing (CMP) or other harsh application environments.
(5) The polydimethylsiloxane superamphiphobic coating prepared by the present invention also has good thermal stability, so that it is suitable for high working temperatures.
(6) In the process of preparing the coating in the present invention, the added filler particles in the coating can simulate a papillary structure on the surface of a lotus leaf to construct a fine micro-nano surface secondary structure, thereby increasing the water and oil contact angles of the coating. Optionally, the filler particles in the present invention may be hydrophobically modified SiO₂ particles, polytetrafluoroethylene particles, or other particles, and a change in the type of nanoparticles has little impact on the hydrophobic and oleophobic properties of the coating.
(7) The modified polydimethylsiloxane superamphiphobic coating provided in the present invention has a wide range of application and is expected to be used in the fields of equipment anti-corrosion, oil-water separation, clothing, electronic product protection, etc.

### BRIEF DESCRIPTION OF THE DRAWINGS

FIG. 1 is a water contact angle test diagram of a modified polydimethylsiloxane superamphiphobic coating prepared in Example 1 of the present invention;

FIG. 2 is an n-hexadecane contact angle test diagram of a modified polydimethylsiloxane superamphiphobic coating prepared in Example 1 of the present invention;

FIG. 3 is a CMP slurry contact angle test diagram of a modified polydimethylsiloxane superamphiphobic coating prepared in Example 1 of the present invention;

FIG. 4 is an infrared test chart of a modified polydimethylsiloxane superamphiphobic coating prepared in Example 1 of the present invention;

FIG. 5 is a roughness test chart of a modified polydimethylsiloxane superamphiphobic coating prepared in Example 1 of the present invention;

FIG. 6 is a thermogravimetric curve chart of a modified polydimethylsiloxane superamphiphobic coating prepared in Example 1 of the present invention;

FIG. 7 is an SEM graph of a modified polydimethylsiloxane superamphiphobic coating prepared in Example 1 of the present invention;

FIG. 8 is an SEM graph of a modified polydimethylsiloxane superamphiphobic coating prepared in Example 1 of the present invention;

FIG. 9 is a water contact angle test diagram of a modified polydimethylsiloxane superamphiphobic coating prepared in Example 11 of the present invention;

FIG. 10 is an n-hexadecane contact angle test diagram of a modified polydimethylsiloxane superamphiphobic coating prepared in Example 11 of the present invention;

FIG. 11 is a CMP slurry contact angle test diagram of a modified polydimethylsiloxane superamphiphobic coating prepared in Example 11 of the present invention;

FIG. 12 is an infrared test chart of a modified polydimethylsiloxane superamphiphobic coating prepared in Example 11 of the present invention;

FIG. 13 is a roughness test chart of a modified polydimethylsiloxane superamphiphobic coating prepared in Example 11 of the present invention;

FIG. 14 is an SEM graph of a modified polydimethylsiloxane superamphiphobic coating prepared in Example 11 of the present invention;

### DETAILED DESCRIPTION OF THE EMBODIMENTS

The present invention will be further described below in conjunction with embodiments, but this does not constitute any limitation on the present invention.

Raw materials used in the embodiments of the present invention were all from commercial sources, where
liquid reagents such as ethanol, acetone, and dichloromethane were purchased from Tianjin Kemiou Chemical Reagent Co., Ltd.;
hydroxyl polydimethylsiloxane and poly(hexamethylene diisocyanate) as a curing agent were purchased from Shenzhen Jipeng Silicon Fluorine Material Co., Ltd., where hydroxyl polydimethylsiloxane had a viscosity of 90 mm²/s (25° C.), a specific gravity of 0.99 (25° C.), a refractive index of 1.413, and a functional group equivalent weight of 30000 g/mol;
pentaerythritol tetrakis(3-mercaptopropionate) was purchased from Shanghai Titan Technology Co., Ltd.;
1H,1H,2H,2H-heptadecafluorodecyl acrylate was purchased from Shanghai Titan Technology Co., Ltd.; and
2,2-dimethoxy-2-phenylacetophenone and benzophenone were purchased from Shanghai Acmec Biochemical Co., Ltd.

### Example 1

A glass sheet with a size of 2 cm (L)×5 cm (W)×0.3 cm (H) was sequentially cleaned with acetone, ethanol, and deionized water, and then dried for later use.

2 g of hydroxyl polydimethylsiloxane was dissolved in 12 mL of dichloromethane; then, 2 g of hydrophobically modified silicon dioxide filler particles with an average particle size of 5 μm and 20 nm (at a mass ratio of 1:5) respectively were added and stirred at 1200 r/min for 20 min; next, 0.9 g of pentaerythritol tetrakis(3-mercaptopropionate) was added and stirred for 1 h; then, 0.3 g of isocyanate was added and further stirred for 30 min; and finally, after ultrasonic defoaming for 10 min, the resulting mixture was applied on the glass sheet by spin coating and cured at room temperature for 8 h. The silicon dioxide filler particles were hydrophobically modified silicon dioxide filler particles.

0.018 g of 2,2-dimethoxy-2-phenylacetophenone and 1.8 g of 1H,1H,2H,2H-heptadecafluorodecyl acrylate were dissolved in 9 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

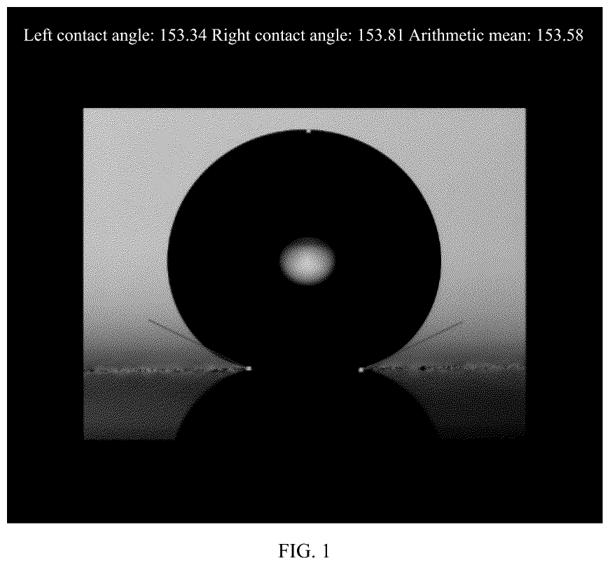

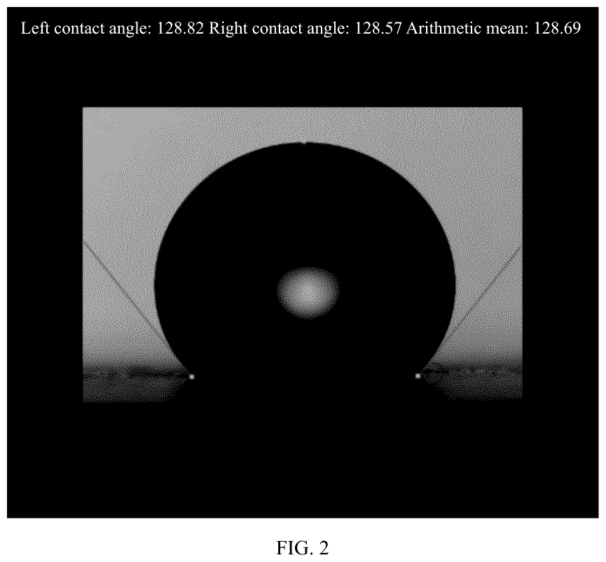

The test results showed that the superamphiphobic coating had a water contact angle of 153.58° and an n-hexadecane contact angle of 128.69°. The test pictures of the contact angles are shown in FIGS. 1 and 2.

### Example 2

A glass sheet with a size of 2 cm (L)×5 cm (W)×0.3 cm (H) was sequentially cleaned with acetone, ethanol, and deionized water, and then dried for later use.

2 g of hydroxyl polydimethylsiloxane was dissolved in 12 mL of acetone; then, 2 g of hydrophobically modified silicon dioxide filler particles with an average particle size of 5 μm and 20 nm (at a mass ratio of 1:5) respectively were added and stirred at 1200 r/min for 20 min; next, 0.9 g of pentaerythritol tetrakis(3-mercaptopropionate) was added and stirred for 1 h; then, 0.3 g of isocyanate was added and further stirred for 30 min; and finally, after ultrasonic defoaming for 10 min, the resulting mixture was applied on the glass sheet by spin coating and cured at room temperature for 8 h. The silicon dioxide filler particles were hydrophobically modified silicon dioxide filler particles.

0.018 g of 2,2-dimethoxy-2-phenylacetophenone and 1.8 g of 1H,1H,2H,2H-heptadecafluorodecyl acrylate were dissolved in 9 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

The test results showed that the superamphiphobic coating had a water contact angle of 132.26° and an n-hexadecane contact angle of 114.75°.

### Example 3

A glass sheet with a size of 2 cm (L)×5 cm (W)×0.3 cm (H) was sequentially cleaned with acetone, ethanol, and deionized water, and then dried for later use.

2 g of hydroxyl polydimethylsiloxane was dissolved in 12 mL of dichloromethane; then, 0.9 g of pentaerythritol tetrakis(3-mercaptopropionate) was added and stirred for 1 h; next, 0.3 g of isocyanate was added and further stirred for 30 min; and finally, after ultrasonic defoaming for 10 min, the resulting mixture was applied on the glass sheet by spin coating and cured at room temperature for 8 h.

0.018 g of 2,2-dimethoxy-2-phenylacetophenone and 1.8 g of 1H,1H,2H,2H-heptadecafluorodecyl acrylate were dissolved in 9 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

The test results showed that the superamphiphobic coating had a water contact angle of 139.81° and an n-hexadecane contact angle of 117.62°.

### Example 4

A glass sheet with a size of 2 cm (L)×5 cm (W)×0.3 cm (H) was sequentially cleaned with acetone, ethanol, and deionized water, and then dried for later use.

2 g of hydroxyl polydimethylsiloxane was dissolved in 12 mL of dichloromethane; then, 1 g of hydrophobically modified silicon dioxide filler particles with an average particle size of 5 μm and 20 nm (at a mass ratio of 1:5) respectively were added and stirred at 1200 r/min for 20 min; next, 0.9 g of pentaerythritol tetrakis(3-mercaptopropionate) was added and stirred for 1 h; then, 0.3 g of isocyanate was added and further stirred for 30 min; and finally, after ultrasonic defoaming for 10 min, the resulting mixture was applied on the glass sheet by spin coating and cured at room temperature for 8 h. The silicon dioxide filler particles were hydrophobically modified silicon dioxide filler particles.

0.018 g of 2,2-dimethoxy-2-phenylacetophenone and 1.8 g of 1H,1H,2H,2H-heptadecafluorodecyl acrylate were dissolved in 9 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

The test results showed that the superamphiphobic coating had a water contact angle of 143.55° and an n-hexadecane contact angle of 122.89°.

### Example 5

A glass sheet with a size of 2 cm (L)×5 cm (W)×0.3 cm (H) was sequentially cleaned with acetone, ethanol, and deionized water, and then dried for later use.

2 g of hydroxyl polydimethylsiloxane was dissolved in 12 mL of dichloromethane; then, 2 g of polytetrafluoroethylene with an average particle size of 4 μm and 20 nm (at a mass ratio of 1:5) respectively were added and stirred at 1200 r/min for 20 min; next, 0.9 g of pentaerythritol tetrakis(3-mercaptopropionate) was added and stirred for 1 h; then, 0.3 g of isocyanate was added and further stirred for 30 min; and finally, after ultrasonic defoaming for 10 min, the resulting mixture was applied on the glass sheet by spin coating and cured at room temperature for 8 h.

0.018 g of 2,2-dimethoxy-2-phenylacetophenone and 1.8 g of 1H,1H,2H,2H-heptadecafluorodecyl acrylate were dissolved in 9 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

The test results showed that the superamphiphobic coating had a water contact angle of 152.33° and an n-hexadecane contact angle of 127.44°.

### Example 6

A glass sheet with a size of 2 cm (L)×5 cm (W)×0.3 cm (H) was sequentially cleaned with acetone, ethanol, and deionized water, and then dried for later use.

2 g of hydroxyl polydimethylsiloxane was dissolved in 12 mL of dichloromethane; then, 2 g of hydrophobically modified silicon dioxide filler particles with an average particle size of 5 μm and 20 nm (at a mass ratio of 1:5) respectively were added and stirred at 1200 r/min for 20 min; next, 0.9 g of pentaerythritol tetrakis(3-mercaptopropionate) was added and stirred for 1 h; then, 0.3 g of isocyanate was added and further stirred for 30 min; and finally, after ultrasonic defoaming for 10 min, the resulting mixture was applied on the glass sheet by spin coating and cured at room temperature for 8 h. The silicon dioxide filler particles were hydrophobically modified silicon dioxide filler particles.

0.018 g of benzophenone and 1.8 g of 1H,1H,2H,2H-heptadecafluorodecyl acrylate were dissolved in 9 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

The test results showed that the superamphiphobic coating had a water contact angle of 149.66° and an n-hexadecane contact angle of 126.93°.

### Example 7

A 304 stainless steel sheet with a size of 2 cm (L)×5 cm (W)×0.3 cm (H) was sequentially cleaned with acetone, ethanol, and deionized water, and then dried for later use.

2 g of hydroxyl polydimethylsiloxane was dissolved in 12 mL of dichloromethane; then, 2 g of hydrophobically modified silicon dioxide filler particles with an average particle size of 5 μm and 20 nm (at a mass ratio of 1:5) respectively were added and stirred at 1200 r/min for 20 min; next, 0.9 g of pentaerythritol tetrakis(3-mercaptopropionate) was added and stirred for 1 h; then, 0.3 g of isocyanate was added and further stirred for 30 min; and finally, after ultrasonic defoaming for 10 min, the resulting mixture was applied on the glass sheet by spin coating and cured at room temperature for 8 h. The silicon dioxide filler particles were hydrophobically modified silicon dioxide filler particles.

0.018 g of 2,2-dimethoxy-2-phenylacetophenone and 1.8 g of 1H,1H,2H,2H-heptadecafluorodecyl acrylate were dissolved in 9 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

The test results showed that the superamphiphobic coating had a water contact angle of 151.15° and an n-hexadecane contact angle of 128.74°.

### Example 8

A cotton cloth with a size of 2 cm (L)×5 cm (W)×0.3 cm (H) was sequentially cleaned with acetone, ethanol, and deionized water, and then dried for later use.

2 g of hydroxyl polydimethylsiloxane was dissolved in 12 mL of dichloromethane; then, 2 g of hydrophobically modified silicon dioxide filler particles with an average particle size of 5 μm and 20 nm (at a mass ratio of 1:5) respectively were added and stirred at 1200 r/min for 20 min; next, 0.9 g of pentaerythritol tetrakis(3-mercaptopropionate) was added and stirred for 1 h; then, 0.3 g of isocyanate was added and further stirred for 30 min; and finally, after ultrasonic defoaming for 10 min, the resulting mixture was applied on the glass sheet by spin coating and cured at room temperature for 8 h. The silicon dioxide filler particles were hydrophobically modified silicon dioxide filler particles.

0.018 g of 2,2-dimethoxy-2-phenylacetophenone and 1.8 g of 1H,1H,2H,2H-heptadecafluorodecyl acrylate were dissolved in 9 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

The test results showed that the superamphiphobic coating had a water contact angle of 153.39° and an n-hexadecane contact angle of 128.23°.

### Example 9

A glass sheet with a size of 2 cm (L)×5 cm (W)×0.3 cm (H) was sequentially cleaned with acetone, ethanol, and deionized water, and then dried for later use.

1.4 g of hydroxyl polydimethylsiloxane was dissolved in 10 mL of dichloromethane; then, 2 g of hydrophobically modified silicon dioxide filler particles with an average particle size of 5 μm and 20 nm (at a mass ratio of 1:5) respectively were added and stirred at 1200 r/min for 20 min; next, 0.9 g of pentaerythritol tetrakis(3-mercaptopropionate) was added and stirred for 1 h; then, 0.09 g of isocyanate was added and further stirred for 30 min; and finally, after ultrasonic defoaming for 10 min, the resulting mixture was applied on the glass sheet by spin coating and cured at room temperature for 8 h. The silicon dioxide filler particles were hydrophobically modified silicon dioxide filler particles.

0.008 g of 2,2-dimethoxy-2-phenylacetophenone and 1.1 g of 1H,1H,2H,2H-heptadecafluorodecyl acrylate were dissolved in 7 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

The test results showed that the superamphiphobic coating had a water contact angle of 150.22° and an n-hexadecane contact angle of 127.67°.

### Example 10

A glass sheet with a size of 2 cm (L)×5 cm (W)×0.3 cm (H) was sequentially cleaned with acetone, ethanol, and deionized water, and then dried for later use.

2.7 g of hydroxyl polydimethylsiloxane was dissolved in 15 mL of dichloromethane; then, 2 g of hydrophobically modified silicon dioxide filler particles with an average particle size of 5 μm and 20 nm (at a mass ratio of 1:5) respectively were added and stirred at 1200 r/min for 20 min; next, 0.9 g of pentaerythritol tetrakis(3-mercaptopropionate) was added and stirred for 1 h; then, 0.36 g of isocyanate was added and further stirred for 30 min; and finally, after ultrasonic defoaming for 10 min, the resulting mixture was applied on the glass sheet by spin coating and cured at room temperature for 8 h. The silicon dioxide filler particles were hydrophobically modified silicon dioxide filler particles.

0.27 g of 2,2-dimethoxy-2-phenylacetophenone and 2.7 g of 1H,1H,2H,2H-heptadecafluorodecyl acrylate were dissolved in 12 mL of ethanol solution; then, the aforementioned glass sheet that was completely cured was immersed into the solution and received UV irradiation with a wavelength of 365 nm and a power of 10 W for 3 h; next, the glass sheet was taken out and placed in an oven of 50° C. for 2 h; and after the surface of the glass sheet was rinsed with anhydrous ethanol, a superamphiphobic coating adhered to the surface of the glass sheet was obtained.

The test results showed that the superamphiphobic coating had a water contact angle of 148.31° and an n-hexadecane contact angle of 126.04°.

### Application Example 1

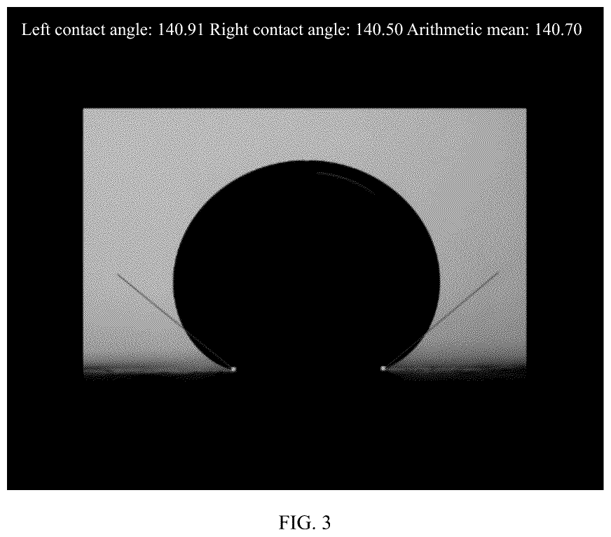

The present invention tested a slurry contact angle on the surface of the coating prepared in Example 1, and the test results are shown in FIG. 3. The test results showed that the coating had a slurry contact angle of 140.7°. After the coating prepared by the present invention was applied on the surface of a planarization device, the surface of the planarization device can be prevented from residual slurry and kept clean. The slurry used in the test was produced by Dalian Zhengyun Technology Co., Ltd. The slurry contained the following ingredients: water, silicon dioxide fillers of 20 nm, potassium permanganate, polyethylene glycol, N-(p-aminoethyl)-r-aminopropyltrimethoxysilane, ethylenediamine, and triethanolamine.

It can be seen from a comparison between Example 1 and Example 2 that when hydroxyl polydimethylsiloxane is dissolved in dichloromethane rather than acetone, since the polarity of dichloromethane is greater than that of acetone, uniform dispersion of siloxane and pentaerythritol tetrakis(3-mercaptopropionate) can be achieved, thereby effectively preventing a phase separation phenomenon, which is more conducive to obtaining a uniform and stable coating and enables the prepared coating with larger water and oil contact angles.

It can be seen from a comparison between Example 1 and Examples 3-4 that filler particles can simulate a papillary structure on the surface of a lotus leaf to construct a fine micro-nano surface secondary structure, thereby increasing the water and oil contact angles of the coating. When no or few filler particles are added, the increase in water and oil contact angles of the prepared coating will be correspondingly reduced.

It can be seen from a comparison between Example 1 and Example 5 that, optionally, the filler particles in the present invention may be hydrophobically modified SiO₂ particles or polytetrafluoroethylene particles, and a change in the type of nanoparticles has little impact on the hydrophobicity of the coating.

It can be seen from a comparison between Example 1 and Example 6 that 2,2-dimethoxy-2-phenylacetophenone and dimethylacetone, as photoinitiators of a thiol-ene click reaction, are different in initiation mechanism that 2,2-dimethoxy-2-phenylacetophenone is based on a cracking mechanism while benzophenone is based on a hydrogen abstraction mechanism, but both of the two can effectively catalyze the thiol-ene click reaction to achieve chemical bonding of fluorinated acrylate on the surface of the coating.

It can be seen from a comparison between Example 1 and Examples 7-8 that the superamphiphobic coating prepared by the present invention can be widely applied on various substrates.

It can be seen from a comparison between Example 1 and Examples 9-10 that the raw materials for preparing the superamphiphobic coating can be adjusted within the composition defined by the present invention and have little impact on the water and oil contact angles of the coating.

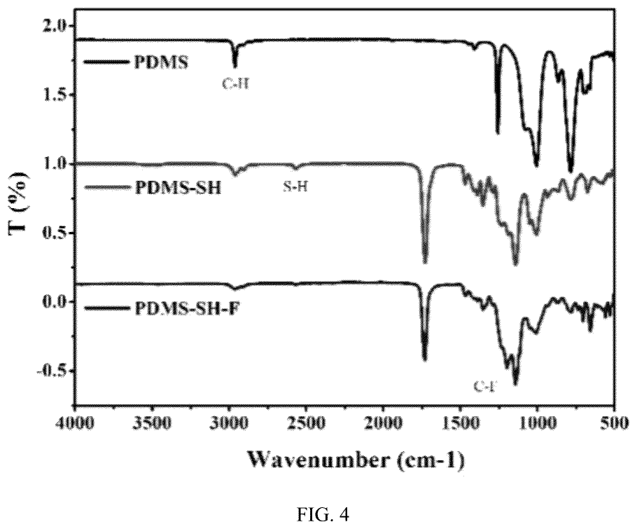

In the present invention, an infrared tester (Bruker Alpha II) was used for performing infrared tests on the coating prepared in Example 1, the raw materials, and intermediate reaction products, and the test results are shown in FIG. 4, where
PDMS represents hydroxyl polydimethylsiloxane.

An infrared absorption peak at 2955 cm⁻¹ was attributed to asymmetric stretching vibration of —CH₃; an infrared absorption peak at 1260 cm⁻¹ was attributed to symmetric bending vibration of —CH₃ groups; strong absorption at 1070 cm⁻¹ was caused by asymmetric stretching vibration of —Si—O—Si— bonds in the hydroxyl polydimethylsiloxane polymers; weak infrared absorption at 905 cm⁻¹ was attributed to stretching vibration of Si—OH; and strong absorption at 790 cm⁻¹ was attributed to stretching vibration of —Si—C bonds.

PDMS-SH represents the coating formed after curing of the mixed solution I.

Sulfhydryl groups were introduced as reactive sites by adding pentaerythritol tetrakis(3-mercaptopropionate) to the PDMS. After the sulfhydryl groups were introduced into the curing system, an infrared spectrum showed that there was still asymmetric stretching vibration characteristic absorption of —CH₃ at 2955 cm⁻¹, and it was found that there was obvious characteristic absorption of S—H at 2565 cm⁻¹, characteristic absorption of C═O at 1730 cm⁻¹, and characteristic absorption of C—O bonds at 1140 cm⁻¹, which all indicated that pentaerythritol tetrakis(3-mercaptopropionate) was successfully involved in the curing of the PDMS, and the remaining-SH could undergo a thiol-double bond click reaction with the fluorinated acrylate.

PDMS-SH-F represents the superamphiphobic coating prepared in Example 1.

An infrared spectrum test after deposition of fluorinated acrylate on the film surface with sulfhydryl groups involved in curing showed that there was obvious characteristic absorption disappearance of S—H at 2565 cm⁻¹, indicating that there was no remaining sulfhydryl group on the film surface; there was an obvious characteristic absorption peak of C—F at 1202 cm⁻¹; and there was no characteristic absorption of C═C at 1620-1680 cm⁻¹, indicating that heptadecafluorodecyl acrylate was deposited on the film surface in the form of chemical bonding. The characteristic absorption of C—O at 1730 cm⁻¹ and the characteristic absorption of C—O bonds at 1140 cm⁻¹ were attributed to the ester group stretching vibration of the heptadecafluorodecyl acrylate.

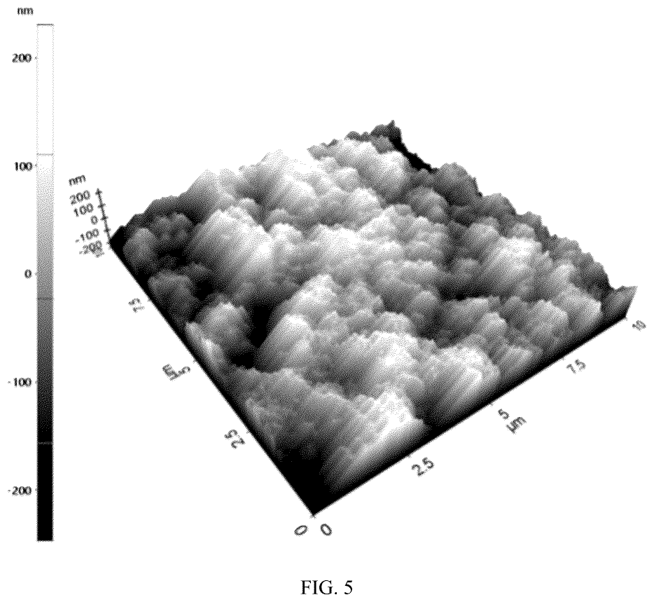

In the present invention, an atomic force microscope (Park NX20) was used for testing the roughness of the superamphiphobic coating prepared in Example 1, the test results are shown in FIG. 5, and the roughness computation results are shown in Table 1.

TABLE 1
Roughness Results of the Coating Prepared in Example 1

| Region | Min(nm) | Max(nm) | Mid(nm) | Mean(nm) | Rpv(nm) | Rq(nm) | Ra(nm) | Rz(nm) | Rsk | Rku |
|---|---|---|---|---|---|---|---|---|---|---|
| Whole | −246.898 | 230.456 | −8.217 | 0.000 | 477.362 | 67.870 | 54.354 | 461.277 | −0.133 | 3.002 |

It can be seen from Table 1 that the line roughness Ra of the coating prepared in Example 1 is Ra=54.354 nm.

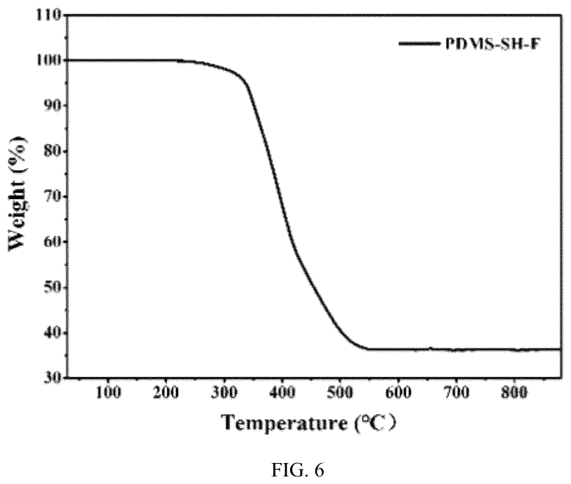

In the present invention, a thermogravimetric analyzer (NETZSCH TG209F3) was used for testing the thermal stability of the coating prepared in Example 1, and the test diagram is shown in FIG. 6. It can be seen from FIG. 6 that the coating prepared in Example 1 has no significant change in weight at 230° C. or below, indicating that the coating prepared by the present invention can be normally used at least within 230° C.

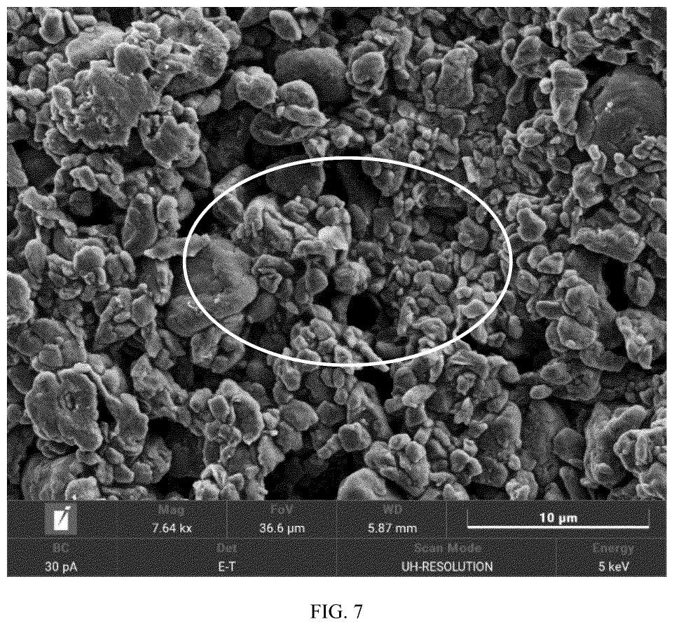

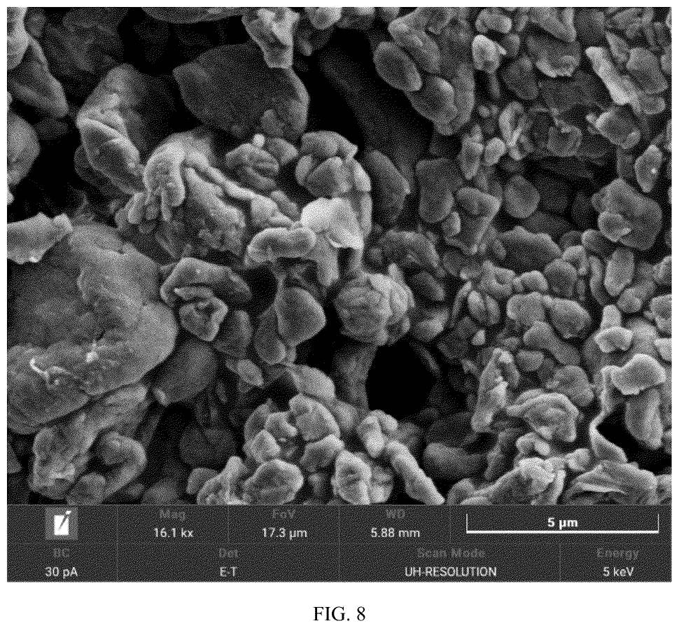

In the present invention, a scanning electron microscope (TescanAMBER) was used for performing morphological observation on the coating prepared in Example 1, and the SEM graphs are shown in FIGS. 7 and 8. It can be seen from FIGS. 7 and 8 that the coating prepared in Example 1 of the present invention forms a micro-nano secondary structure.

In the present invention, the coating prepared in Example 1 was subjected to a chemical resistance test, and the test results are shown in Table 2.

TABLE 2
Chemical Resistance Test Results of
the Coating Prepared in Example 1

| Test Condition | Example 1 |
|---|---|
| 1M HCl (48 h) | 152.67/127.94 |
| 1M NaOH(48 h) | 150.33/127.16 |
| 1M NaCl(48 h) | 151.02/127.82 |

Three pieces of the same steel were taken as substrates, and after the coating prepared in Example 1 of the present invention was applied on all surfaces of the substrates, the three pieces of substrates were immersed in 1M HCl solution for 48 h, in 1M NaOH solution for 48 h, and in 1M NaCl solution for 48 h respectively to test the corrosion resistance of the coating.

No signs of coating damage were observed on the surfaces of the substrates, and hydrophobic and oleophobic angles of the coating were measured. The results are shown in Table 2. The results indicate that the coating prepared in Example 1 has good corrosion resistance.

In the present invention, the coatings prepared in Examples 1-10 were subjected to mechanical property tests, and the test results are shown in Table 3.

### (1) Abrasion Resistance Test:

A substrate coated with the polydimethylsiloxane superamphiphobic coating prepared by the present invention was horizontally placed; then, 320-mesh abrasive paper with an area of about ⅓ of the area of the polydimethylsiloxane superamphiphobic coating was placed on the surface of the substrate; next, a glass sheet with the same area as the abrasive paper was placed on the adhesive side of the abrasive paper and adhered to the abrasive paper through the adhesive to avoid relative sliding between the two; and finally, a counterweight was placed on the glass sheet to ensure that the polydimethylsiloxane superamphiphobic coating was in contact with the surface of the abrasive paper, the abrasive paper was moved at a speed of v=0.5 mm/s, and the corresponding smallest weight of the counterweight when the scratch depth in the surface of the polydimethylsiloxane superamphiphobic coating ≥1 μm was recorded to measure the abrasion resistance of the coating.

### (2) Hardness Test:

The hardness of an abrasion resistant coating on the surface of the polydimethylsiloxane superamphiphobic coating prepared by the present invention was tested by a pencil hardness method.

### (3) Adhesion Test:

The adhesion between the polydimethylsiloxane superamphiphobic coating prepared by the present invention and the substrate was tested according to the GB/T 9286-1998 standard. A grid array of 10*10 was cut in the surface of the coating with a blade; then, a 3M adhesive tape was stuck to the surface of the cut grid; next, the surface of the adhesive tape was forcefully wiped with a rubber to ensure that the adhesive tape was securely stuck to the surface of the grid, and then one end of the adhesive tape was manually grabbed to tear the adhesive tape in a 90-degree direction so as to test the adhesion of the coating.

TABLE 3
Mechanical Property Test Results of the
Coatings Prepared in Examples 1-10

| | Mechanical Property Tests of Coatings | | |
|---|---|---|---|
| | Abrasion | | |
| Sample No. | resistance/g | Hardness | Adhesion |
| Example 1 | 34 | 3H | 4B |
| Example 2 | 30 | 2H | 3B |
| Example 3 | 27 | 2B | 4B |
| Example 4 | 30 | 2H | 4B |
| Example 5 | 33 | 3H | 4B |
| Example 6 | 33 | 3H | 4B |
| Example 7 | 33 | 3H | 4B |
| Example 8 | 32 | 3H | 4B |
| Example 9 | 30 | 2H | 4B |
| Example 10 | 32 | 3H | 4B |

It can be seen from a comparison between Example 1 and Example 2 that when hydroxyl polydimethylsiloxane is dissolved in dichloromethane in Example 1 rather than acetone, since the polarity of dichloromethane is greater than that of acetone, uniform dispersion of siloxane and pentaerythritol tetrakis(3-mercaptopropionate) can be achieved, thereby effectively preventing a phase separation phenomenon, which is conducive to obtaining a uniform and stable coating. Thus, the superamphiphobic coating prepared in Example 1 has better mechanical properties than that prepared in Example 2.

It can be seen from a comparison between Example 1 and Examples 3-4 that a certain quantity of filler particles exist in the coating and can simulate a papillary structure on the surface of a lotus leaf to construct a fine micro-nano surface secondary structure, thereby increasing the mechanical properties of the coating.

It can be seen from a comparison between Example 1 and Example 5 that, optionally, the filler particles in the present invention may be hydrophobically modified SiO₂ particles or polytetrafluoroethylene particles, and a change in the type of nanoparticles has little impact on the mechanical properties of the coating.

It can be seen from a comparison between Example 1 and Example 6 that choosing 2,2-dimethoxy-2-phenylacetophenone or dimethylacetone as the photoinitiator of the thiol-ene click reaction has little impact on the mechanical properties of the prepared coating.

It can be seen from a comparison between Example 1 and Examples 7-8 that the superamphiphobic coating prepared by the present invention can be widely applied on various substrates and has no significant changes in mechanical properties.

It can be seen from a comparison between Example 1 and Examples 9-10 that the raw materials for preparing the superamphiphobic coating of the present invention can be adjusted within the composition defined by the present invention and have little impact on the mechanical properties of the prepared coating.

### Example 11

A glass sheet with a size of 2 cm×5 cm×0.3 cm was sequentially cleaned with acetone, ethanol, and deionized water, and then dried for later use.

5 g of hydroxyl polydimethylsiloxane was dissolved in 34 mL of dichloromethane; then, 0.25 g of pentaerythritol tetrakis(3-mercaptopropionate) was added and stirred for reaction for 30 min; next, 0.5 g of 1H, 1H,2H,2H-heptadecafluorodecyl acrylate and 0.005 g of 2,2-dimethoxy-2-phenylacetophenone were added to obtain a mixed solution; then, the mixed solution was stirred (at 500 rpm) for reaction for 5 h under UV irradiation with a wavelength of 365 nm and a power of 10 W; and then, 0.9 g of hydrophobically modified silicon dioxide filler particles (a mass ratio of the silicon dioxide filler particles of 10 μm to those of 20 nm was 1:2) were added to the mixed solution and received ultrasonic dispersion for 30 min; next, 1 g of poly(hexamethylene diisocyanate) was added and further received ultrasonic dispersion for 10 min, following which defoaming treatment was performed to obtain a coating solution; and finally, the coating solution was applied on the surface of the substrate by brush coating and cured at room temperature for 8 h to obtain the superamphiphobic coating.

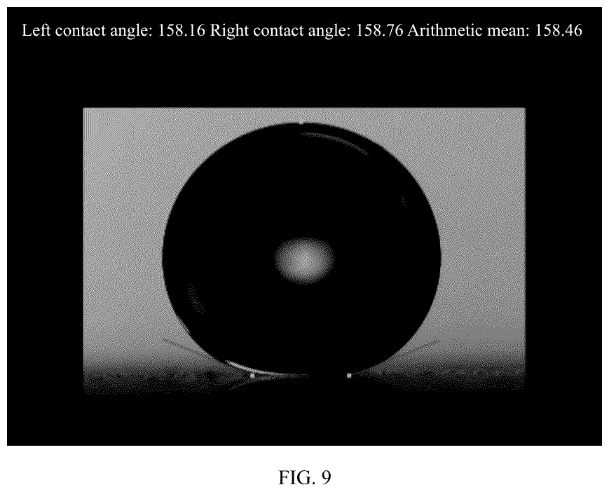

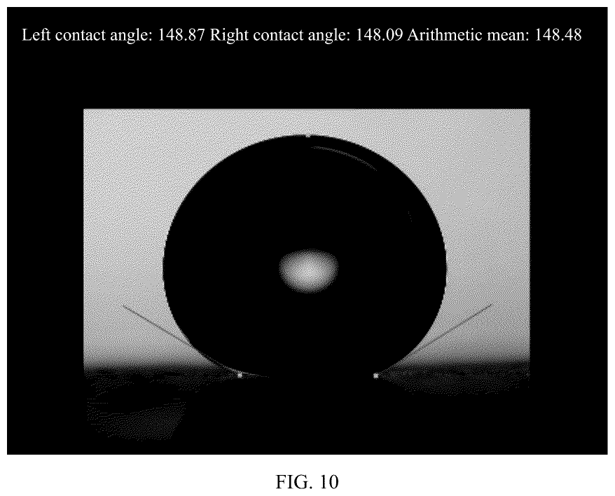

The test results showed that the superamphiphobic coating had a water contact angle of 158.5° and an n-hexadecane contact angle of 148.5°. The test pictures of the contact angles are shown in FIGS. 9 and 10.

### Example 12

A glass sheet with a size of 2 cm×5 cm×0.3 cm was sequentially cleaned with acetone, ethanol, and deionized water, and then dried for later use.

5 g of hydroxyl polydimethylsiloxane was dissolved in 34 mL of acetone; then, 0.25 g of pentaerythritol tetrakis(3-mercaptopropionate) was added and stirred for reaction for 30 min; next, 0.5 g of 1H, 1H,2H,2H-heptadecafluorodecyl acrylate and 0.005 g of 2,2-dimethoxy-2-phenylacetophenone were added to obtain a mixed solution; and finally, the mixed solution was stirred (at 500 rpm) for reaction for 5 h under UV irradiation with a wavelength of 365 nm and a power of 10 W, and then, 0.9 g of hydrophobically modified silicon dioxide filler particles (a mass ratio of the silicon dioxide filler particles of 10 μm to those of 20 nm was 1:2) were added to the mixed solution and received ultrasonic dispersion for 30 min; next, 1 g of poly(hexamethylene diisocyanate) was added and further received ultrasonic dispersion for 10 min, following which defoaming treatment was performed to obtain a coating solution; and finally, the coating solution was applied on the surface of the substrate by brush coating and cured at room temperature for 8 h to obtain the superamphiphobic coating.

The test results showed that the superamphiphobic coating had a water contact angle of 158.36° and an n-hexadecane contact angle of 147.2°.

### Example 13

A glass sheet with a size of 2 cm×5 cm×0.3 cm was sequentially cleaned with acetone, ethanol, and deionized water, and then dried for later use.

5 g of hydroxyl polydimethylsiloxane was dissolved in 34 mL of dichloromethane; then, 0.25 g of pentaerythritol tetrakis(3-mercaptopropionate) was added and stirred for reaction for 30 min; next, 0.5 g of 1H,1H,2H,2H-heptadecafluorodecyl acrylate and 0.005 g of 2,2-dimethoxy-2-phenylacetophenone were added to obtain a mixed solution; then, the mixed solution was stirred (at 500 rpm) for reaction for 5 h under UV irradiation with a wavelength of 365 nm and a power of 10 W; and then, 1 g of poly(hexamethylene diisocyanate) was added to the mixed solution and received ultrasonic dispersion for 10 min, following which defoaming treatment was performed to obtain a coating solution; and finally, the coating solution was applied on the surface of the substrate by brush coating and cured at room temperature for 8 h to obtain the superamphiphobic coating.

The test results showed that the superamphiphobic coating had a water contact angle of 145.7° and an n-hexadecane contact angle of 134.2°.

### Example 14

A glass sheet with a size of 2 cm×5 cm×0.3 cm was sequentially cleaned with acetone, ethanol, and deionized water, and then dried for later use.

5 g of hydroxyl polydimethylsiloxane was dissolved in 34 mL of dichloromethane; then, 0.25 g of pentaerythritol tetrakis(3-mercaptopropionate) was added and stirred for reaction for 30 min; next, 0.5 g of 1H, 1H,2H,2H-heptadecafluorodecyl acrylate and 0.005 g of benzophenone were added to obtain a mixed solution; then, the mixed solution was stirred (at 500 rpm) for reaction for 5 h under UV irradiation with a wavelength of 365 nm and a power of 10 W; and then, 0.9 g of hydrophobically modified silicon dioxide filler particles (a mass ratio of the silicon dioxide filler particles of 10 μm to those of 20 nm was 1:2) were added to the mixed solution and received ultrasonic dispersion for 30 min; next, 1 g of poly(hexamethylene diisocyanate) was added and further received ultrasonic dispersion for 10 min, following which defoaming treatment was performed to obtain a coating solution; and finally, the coating solution was applied on the surface of the substrate by brush coating and cured at room temperature for 8 h to obtain the superamphiphobic coating.

The test results showed that the superamphiphobic coating had a water contact angle of 157.9° and an n-hexadecane contact angle of 146.6°.

### Example 15

A stainless steel sheet with a size of 2 cm×5 cm×0.3 cm was sequentially cleaned with acetone, ethanol, and deionized water, and then dried for later use.

5 g of hydroxyl polydimethylsiloxane was dissolved in 34 mL of dichloromethane; then, 0.25 g of pentaerythritol tetrakis(3-mercaptopropionate) was added and stirred for reaction for 30 min; next, 0.5 g of 1H,1H,2H,2H-heptadecafluorodecyl acrylate and 0.005 g of 2,2-dimethoxy-2-phenylacetophenone were added to obtain a mixed solution; then, the mixed solution was stirred (at 500 rpm) for reaction for 5 h under UV irradiation with a wavelength of 365 nm and a power of 10 W; and then, 0.9 g of hydrophobically modified silicon dioxide filler particles (a mass ratio of the silicon dioxide filler particles of 10 μm to those of 20 nm was 1:2) were added to the mixed solution and received ultrasonic dispersion for 30 min; next, 1 g of poly(hexamethylene diisocyanate) was added and further received ultrasonic dispersion for 10 min, following which defoaming treatment was performed to obtain a coating solution; and finally, the coating solution was applied on the surface of the substrate by brush coating and cured at room temperature for 8 h to obtain the superamphiphobic coating.

The test results showed that the superamphiphobic coating had a water contact angle of 157.2° and an n-hexadecane contact angle of 148.1°.

### Example 16

A glass sheet with a size of 2 cm×5 cm×0.3 cm was sequentially cleaned with acetone, ethanol, and deionized water, and then dried for later use.

5 g of hydroxyl polydimethylsiloxane was dissolved in 34 mL of dichloromethane; then, 0.25 g of pentaerythritol tetrakis(3-mercaptopropionate) was added and stirred for reaction for 30 min; next, 0.5 g of 1H, 1H,2H,2H-heptadecafluorodecyl acrylate and 0.005 g of 2,2-dimethoxy-2-phenylacetophenone were added to obtain a mixed solution; then, the mixed solution was stirred (at 500 rpm) for reaction for 5 h under UV irradiation with a wavelength of 365 nm and a power of 10 W; and then, 0.9 g of polytetrafluoroethylene (a mass ratio of 10 μm polytetrafluoroethylene particles to 20 nm silicon dioxide filler particles was 1:2) was added to the mixed solution and received ultrasonic dispersion for 30 min; next, 1 g of poly(hexamethylene diisocyanate) was added and further received ultrasonic dispersion for 10 min, following which defoaming treatment was performed to obtain a coating solution; and finally, the coating solution was applied on the surface of the substrate by brush coating and cured at room temperature for 8 h to obtain the superamphiphobic coating.

The test results showed that the superamphiphobic coating had a water contact angle of 156.9° and an n-hexadecane contact angle of 147.3°.

### Example 17

A glass sheet with a size of 2 cm×5 cm×0.3 cm was sequentially cleaned with acetone, ethanol, and deionized water, and then dried for later use.

4.5 g of hydroxyl polydimethylsiloxane was dissolved in 34 mL of dichloromethane; then, 0.25 g of pentaerythritol tetrakis(3-mercaptopropionate) was added and stirred for reaction for 30 min; next, 0.25 g of 1H,1H,2H,2H-heptadecafluorodecyl acrylate and 0.025 g of 2,2-dimethoxy-2-phenylacetophenone were added to obtain a mixed solution; then, the mixed solution was stirred (at 500 rpm) for reaction for 5 h under UV irradiation with a wavelength of 365 nm and a power of 10 W; and then, 0.9 g of hydrophobically modified silicon dioxide filler particles (a mass ratio of the silicon dioxide filler particles of 10 μm to those of 20 nm was 1:2) were added to the mixed solution and received ultrasonic dispersion for 30 min; next, 0.75 g of poly(hexamethylene diisocyanate) was added and further received ultrasonic dispersion for 10 min, following which defoaming treatment was performed to obtain a coating solution; and finally, the coating solution was applied on the surface of the substrate by brush coating and cured at room temperature for 8 h to obtain the superamphiphobic coating.

The test results showed that the superamphiphobic coating had a water contact angle of 156.32° and an n-hexadecane contact angle of 146.9°.

### Example 18

A glass sheet with a size of 2 cm×5 cm×0.3 cm was sequentially cleaned with acetone, ethanol, and deionized water, and then dried for later use.

6.25 g of hydroxyl polydimethylsiloxane was dissolved in 34 mL of dichloromethane; then, 0.25 g of pentaerythritol tetrakis(3-mercaptopropionate) was added and stirred for reaction for 30 min; next, 0.625 g of 1H,1H,2H,2H-heptadecafluorodecyl acrylate and 0.0315 g of 2,2-dimethoxy-2-phenylacetophenone were added to obtain a mixed solution; then, the mixed solution was stirred (at 500 rpm) for reaction for 5 h under UV irradiation with a wavelength of 365 nm and a power of 10 W; and then, 0.9 g of hydrophobically modified silicon dioxide filler particles (a mass ratio of the silicon dioxide filler particles of 10 μm to those of 20 nm was 1:2) were added to the mixed solution and received ultrasonic dispersion for 30 min; next, 1.5 g of poly(hexamethylene diisocyanate) was added and further received ultrasonic dispersion for 10 min, following which defoaming treatment was performed to obtain a coating solution; and finally, the coating solution was applied on the surface of the substrate by brush coating and cured at room temperature for 8 h to obtain the superamphiphobic coating.

The test results showed that the superamphiphobic coating had a water contact angle of 155.1° and an n-hexadecane contact angle of 146.7°.

### Application Example 2

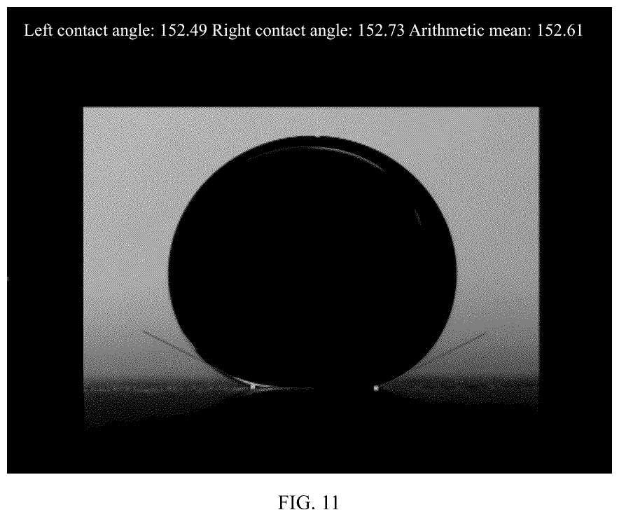

The present invention tested a slurry contact angle on the surface of the coating prepared in Example 11, and the test results are shown in FIG. 11. The test results showed that the coating had a slurry contact angle of 152.61°. After the coating prepared by the present invention was applied on the surface of a planarization device, the surface of the planarization device can be prevented from residual slurry and kept clean. The slurry used in the test was produced by Dalian Zhengyun Technology Co., Ltd. The slurry contained the following ingredients: water, silicon dioxide fillers of 20 nm, potassium permanganate, polyethylene glycol, N-(p-aminoethyl)-r-aminopropyltrimethoxysilane, ethylenediamine, and triethanolamine.

### Application Example 3

Microcracks were made in the surface of the coating prepared in Example 11 with abrasive paper, a knife, or other hard materials to obtain a micro-damaged surface, and then the damaged surface received UV irradiation with a wavelength of 365 nm for 30 min, so that the microcracks were self-restored. The test results showed that the self-restored position had a water contact angle of 157.1° and an n-hexadecane contact angle of 148.3°. The coating prepared by the method according to the present invention had a certain self-healing property, which was attributed to S—C bonds contained in the coating. After the thiol-ene click reaction was induced by UV irradiation, the S—C bonds at the damaged position were re-bonded to obtain a siloxane elastomer with a dynamic cross-linked network, thereby enabling the micro-damage of the coating to be restored.

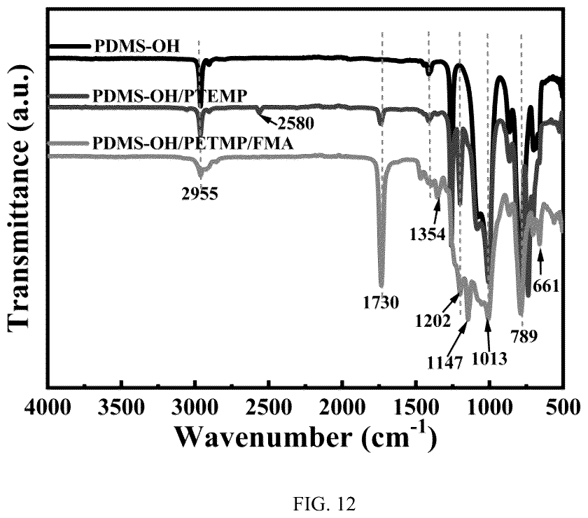

In the present invention, an infrared tester (Bruker Alpha II) was used for performing infrared tests on the coating prepared in Example 11, the raw materials, and intermediate reaction products, and the test results are shown in FIG. 12, where

PDMS-OH represents an infrared spectrum of the coating cured with hydroxyl polydimethylsiloxane.

An infrared absorption peak at 2955 cm⁻¹ was attributed to asymmetric stretching vibration of —CH₃; an infrared absorption peak at 1260 cm⁻¹ was attributed to symmetric bending vibration of —CH₃ groups; strong absorption at 1070 cm⁻¹ was caused by asymmetric stretching vibration of —Si—O—Si— bonds in the hydroxyl polydimethylsiloxane; weak infrared absorption at 905 cm⁻¹ was attributed to stretching vibration of Si—OH; and strong absorption at 789 cm⁻¹ was attributed to stretching vibration of —Si—C bonds.

PDMS-OH/PETMP represents an infrared spectrum of the coating obtained after adding pentaerythritol tetrakis(3-mercaptopropionate) (PETMP) to the hydroxyl polydimethylsiloxane and curing.

An infrared spectrum of the coating obtained after adding pentaerythritol tetrakis(3-mercaptopropionate) (PETMP) to PDMS-OH resins and curing showed that there was still asymmetric stretching vibration characteristic absorption of —CH₃ at 2955 cm⁻¹, and it was found that there was obvious characteristic absorption of S—H at 2580 cm⁻¹, characteristic absorption of C═O at 1730 cm⁻¹, and characteristic absorption of C—O bonds at 1147 cm⁻¹, which all indicated that pentaerythritol tetrakis(3-mercaptopropionate) was successfully subjected to graft polymerization with hydroxyl polydimethylsiloxane, and the remaining-SH could undergo a thiol-double bond click reaction with the fluorinated acrylate.

PDMS/PETMP/FMA represents the superamphiphobic coating prepared in Example 11.

An infrared spectrum of the coating obtained after adding pentaerythritol tetrakis(3-mercaptopropionate) (PETMP) and fluorinated acrylate (FMA) to PDMS-OH resins and curing showed that there was obvious characteristic absorption disappearance of S—H at 2580 cm⁻¹, indicating that there was no remaining sulfhydryl group in the film of the coating; there was an obvious characteristic absorption peak of C—F at 1202 cm⁻¹; and there was no characteristic absorption of C═C at 1620-1680 cm⁻¹, indicating that heptadecafluorodecyl acrylate in the form of chemical bonding was grafted to chain segments of siloxane resin polymers. The characteristic absorption of C═O at 1730 cm⁻¹ and the characteristic absorption of C—O bonds at 1147 cm⁻¹ were attributed to the ester group stretching vibration of heptadecafluorodecyl acrylate, indicating that fluorinated acrylate had been successfully grafted to chain segments of siloxane resins modified with the sulfhydryl compound.

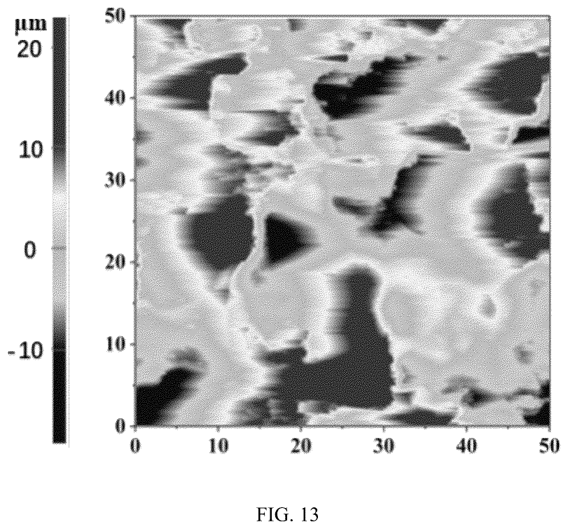

In the present invention, an atomic force microscope (Park NX20) was used for testing the roughness of the superamphiphobic coating prepared in Example 11, the test results are shown in FIG. 13, and the roughness computation results are shown in Table 4.

TABLE 4
Roughness Results of the Coating Prepared in Example 11

| Region | Min(nm) | Max(nm) | Mid(nm) | Mean(nm) | Rpv(nm) | Ra(nm) |
|---|---|---|---|---|---|---|
| Whole | −2582.797 | 3577.303 | 994.506 | 0.000 | 6160.1 | 5437.1 |

It can be seen from Table 4 that the line roughness Ra of the coating prepared in Example 11 is Ra=5.437±1.61 μm.

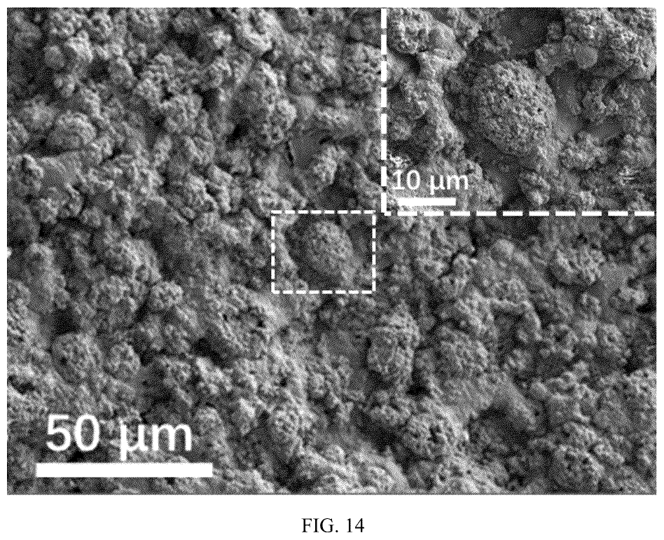

The roughness of the surface of the prepared coating was 5.437 μm (FIG. 13); micron particles were in island distribution; nanoparticles were gathered on the surfaces of the micron particles (further proved in FIG. 14); and meanwhile, a contact model of liquid drops on the surface of the coating was similar to a Cassie model, and high water and oil contact angles were observed.

In the present invention, the coatings prepared in Examples 11-18 were subjected to mechanical property tests, and the test results are shown in Table 5.

### (1) Abrasion Resistance Test:

A substrate coated with the polydimethylsiloxane superamphiphobic coating prepared by the present invention was horizontally placed; then, 320-mesh abrasive paper with an area of about ⅓ of the area of the polydimethylsiloxane superamphiphobic coating was placed on the surface of the substrate; next, a glass sheet with the same area as the abrasive paper was placed on the adhesive side of the abrasive paper and adhered to the abrasive paper through the adhesive to avoid relative sliding between the two; and finally, a counterweight was placed on the glass sheet to ensure that the polydimethylsiloxane superamphiphobic coating was in contact with the surface of the abrasive paper, the abrasive paper was moved at a speed of v=0.5 mm/s, and the corresponding smallest weight of the counterweight when the scratch depth in the surface of the polydimethylsiloxane superamphiphobic coating ≥1 μm was recorded to measure the abrasion resistance of the coating.

### (2) Hardness Test:

The hardness of an abrasion resistant coating on the surface of the polydimethylsiloxane superamphiphobic coating prepared by the present invention was tested by a pencil hardness method.

### (3) Adhesion Test:

The adhesion between the polydimethylsiloxane superamphiphobic coating prepared by the present invention and the substrate was tested according to the GB/T 9286-1998 standard. A grid array of 10*10 was cut in the surface of the coating with a blade; then, a 3M adhesive tape was stuck to the surface of the cut grid; next, the surface of the adhesive tape was forcefully wiped with a rubber to ensure that the adhesive tape was securely stuck to the surface of the grid, and then one end of the adhesive tape was manually grabbed to tear the adhesive tape in a 90-degree direction so as to test the adhesion of the coating.

TABLE 5
Mechanical Property Test Results of the
Coatings Prepared in Examples 11-18

| | Abrasion Resistant Properties of Coatings | | |
|---|---|---|---|
| | Abrasion | | |
| Sample No. | resistance/g | Hardness | Adhesion |
| Example 11 | 200 | 4H | 4B |
| Example 12 | 195 | 4H | 4B |
| Example 13 | 122 | 4H | 4B |
| Example 14 | 187 | 4H | 4B |
| Example 15 | 190 | 4H | 4B |
| Example 16 | 192 | 4H | 4B |
| Example 17 | 183 | 4H | 4B |
| Example 18 | 178 | 4H | 4B |

In the present invention, the coating prepared in Example 11 was subjected to a chemical resistance test, and the test results are shown in Table 6.

TABLE 6
Chemical Resistance Test Results of
the Coating Prepared in Example 11

| Test Condition | Example 1 |
|---|---|
| 1M HCl (48 h) | 158.35/147.26 |
| 1M NaOH(48 h) | 157.86/148.07 |
| 1M NaCl(48 h) | 157.64/147.68 |

Three pieces of the same steel were taken as substrates, and after the coating prepared in Example 11 of the present invention was applied on all surfaces of the substrates, the three pieces of substrates were immersed in 1M HCl solution for 48 h, in 1M NaOH solution for 48 h, and in 1M NaCl solution for 48 h respectively to test the corrosion resistance of the coating.

No signs of coating damage were observed on the surfaces of the substrates, and hydrophobic and oleophobic angles of the coating were measured. The results are shown in Table 6. The results indicate that the coating prepared in Example 11 has good corrosion resistance.

It should be noted that the examples described above are only intended to explain rather than limit the present invention. The present invention has been described with reference to typical examples, but it should be understood that the terms used herein are descriptive and explanatory rather than restrictive. The present invention may be modified within the scope of the claims of the present invention as prescribed, and may be amended without departing from the scope and spirit of the present invention. Although the present invention described herein relates to specific methods, materials, and examples, it is not meant that the present invention is limited to the examples disclosed therein. On the contrary, the present invention may be extended to all other methods and applications with the same function.

What is claimed is:

1. A polydimethylsiloxane superamphiphobic coating, comprising the following raw materials: hydroxyl polydimethylsiloxane, a sulfhydryl compound, fluorinated acrylate, a curing agent, and an initiator.

2. The polydimethylsiloxane superamphiphobic coating of claim 1, wherein a mass ratio of the hydroxyl polydimethylsiloxane, the sulfhydryl compound, and the curing agent is (1-3):1:(0.1-0.4); and
a mass ratio of the sulfhydryl compound, the fluorinated acrylate, and the initiator is 1:(0.6-3):(0.01-0.3).

3. The polydimethylsiloxane superamphiphobic coating of claim 2, wherein the raw materials for preparing the polydimethylsiloxane superamphiphobic coating further comprise filler particles, and a mass ratio of the hydroxyl polydimethylsiloxane to the filler particles is 1:(0.5-2.5).

4. The polydimethylsiloxane superamphiphobic coating of claim 3, wherein the filler particles comprise micron-sized particles and nano-sized particles;
the micron-sized particles have a particle size of 2-10 μm, and the nano-sized particles have a particle size of 10-30 nm; and
the micron-sized particles and the nano-sized particles are each independently selected from one or more of hydrophobically modified SiO₂, TiO₂, Al₂O₃, polytetrafluoroethylene, fluorinated graphite, and hollow glass microspheres.

5. The polydimethylsiloxane superamphiphobic coating of claim 4, wherein the polydimethylsiloxane superamphiphobic coating has a water contact angle of 132° to 154° and an oil contact angle of 114° to 129°.

6. The polydimethylsiloxane superamphiphobic coating of claim 1, wherein on the basis of a mass of the hydroxyl polydimethylsiloxane being 100%, a mass of the sulfhydryl compound is 1%-10%, a mass of the fluorinated acrylate is 2%-20%, a mass of the initiator is 0.01%-1%, and a mass of the curing agent is 10%-30%.

7. The polydimethylsiloxane superamphiphobic coating of claim 1, wherein the raw materials for preparing the polydimethylsiloxane superamphiphobic coating further comprise filler particles, and a mass ratio of the hydroxyl polydimethylsiloxane to the filler particles is 1:(0.1-1).

8. The polydimethylsiloxane superamphiphobic coating of claim 7, wherein the filler particles comprise micron-sized particles and nano-sized particles;
preferably, the micron-sized particles have a particle size of 5-15 μm, the nano-sized particles have a particle size of 10-30 nm, and a mass ratio of the micron-sized particles to the nano-sized particles is 1: (1-5); and
preferably, the micron-sized particles and the nano-sized particles are each independently selected from one or more of the following: hydrophobically modified SiO₂, TiO₂, Al₂O₃, polytetrafluoroethylene, fluorinated graphite, and hollow glass microspheres.

9. The polydimethylsiloxane superamphiphobic coating of claim 8, wherein the polydimethylsiloxane superamphiphobic coating has a water contact angle of 145° to 159° and an oil contact angle of 134° to 149°; and/or, abrasion resistance of 122 g to 200 g; and/or, hardness of 4H; and/or, adhesion of 4B.

10. A preparation method of the polydimethylsiloxane superamphiphobic coating according to claim 1, comprising the following steps:
(1) preparing a mixed solution I using the hydroxyl polydimethylsiloxane, the sulfhydryl compound, the curing agent, and a solvent I, applying the mixed solution I on a surface of a substrate, and allowing for curing; and
(2) preparing a mixed solution II using the fluorinated acrylate, the initiator, and a solvent II, immersing the substrate cured with the mixed solution I prepared in the step (1) in the mixed solution II, and performing irradiation aging to obtain the polydimethylsiloxane superamphiphobic coating.

11. The preparation method of claim 10, wherein the raw materials for preparing the polydimethylsiloxane superamphiphobic coating further comprise filler particles;
in the step (1), the mixed solution I is prepared using the hydroxyl polydimethylsiloxane, the sulfhydryl compound, the filler particles, the curing agent, and the solvent I; and
the filler particles account for 5%-20% of the mixed solution I by weight.

12. The preparation method of claim 11, wherein the hydroxyl polydimethylsiloxane accounts for 10%-20% of the solvent I by weight;
the fluorinated acrylate accounts for 20%-30% of the mixed solution II by weight; and
the initiator accounts for 0.1%-3% of the mixed solution II by weight.

13. The preparation method of the polydimethylsiloxane superamphiphobic coating of claim 12, wherein
in the step (1), the mixed solution I is stirred and defoamed, and then applied on the surface of the substrate;
and/or, in the step (1), a curing condition comprises curing for 8-12 h;
and/or, in the step (2), an irradiation condition comprises UV irradiation with a wavelength of 300-380 nm, a power of 8-12 W, and an irradiation time of 2-8 h;
and/or, in the step (2), an aging condition comprises aging at a temperature of 40-60° C. for 1-5 h.

14. A preparation method of the polydimethylsiloxane superamphiphobic coating according to claim 6, comprising the following steps:
mixing the hydroxyl polydimethylsiloxane, the sulfhydryl compound, the fluorinated acrylate, the initiator, and a solvent to obtain a mixed solution; performing irradiation on the mixed solution; adding the curing agent to obtain a coating solution; applying the coating solution on a surface of a substrate; and allowing for curing to obtain the polydimethylsiloxane superamphiphobic coating.

15. The preparation method of claim 14, wherein the raw materials for preparing the polydimethylsiloxane superamphiphobic coating further comprise filler particles; the preparation method further comprises: adding the filler particles after the step of performing irradiation on the mixed solution and before the step of adding the curing agent; and
preferably, the filler particles account for 1%-3% of the mixed solution by weight.

16. The preparation method of claim 14, wherein the hydroxyl polydimethylsiloxane accounts for 9%-20% of the solvent by weight;
and/or, the sulfhydryl compound accounts for 0.4%-1% of the solvent by weight;
and/or, the fluorinated acrylate accounts for 0.5%-2% of the solvent by weight.

17. The preparation method of claim 14, wherein
the preparation method further comprises: after the step of adding the curing agent, performing ultrasound treatment and defoaming to obtain the coating solution, and applying the coating solution on the surface of the substrate;
and/or, an irradiation condition comprises UV irradiation with a wavelength of 300-380 nm, a power of 5-20 W, and an irradiation time of 2-8 h;
and/or, a curing condition comprises curing at room temperature for 8-12 h.

18. The preparation method of claim 10, wherein
the sulfhydryl compound comprises at least one or more of pentaerythritol tetrakis(3-mercaptopropionate), dipentaerythritol hexakis (3-mercaptopropionate), trimethylolpropane tris(3-mercaptopropionate), 4-arm-PEG-SH, 3-mercapto-1-propanol, 1,4-butanediol bis(thioglycolate), bis(2-mercaptoethyl) adipate, diisopropyl 2,3-dimercaptosuccinate, 1,4-butanedithiol, and glycol dimercaptoacetate;
the curing agent comprises at least one or more of isocyanate, acetic acid, butylenediamine, butanone oxime, and 2-butanone oxime;
the fluorinated acrylate comprises at least one or more of 1H, 1H,2H,2H-heptadecafluorodecyl acrylate, 1H, 1H,2H,2H-perfluorooctyl methacrylate, 2-(perfluorohexyl)ethyl methacrylate, 2-(perfluorooctyl)ethyl methacrylate, 2-(perfluoroalkyl)ethyl methacrylate, 1H,1H,2H,2H-perfluorooctyl acrylate, eicosafluoroundecyl acrylate, and 2-(perfluorobutyl)ethyl methacrylate;
the initiator comprises at least one or more of 2,2-dimethoxy-2-phenylacetophenone, benzophenone, and photoinitiator-184;
the substrate is selected from one of glass sheets, steel, wood, paper, marble, and cotton; and
the solvent is selected from one or more of dichloromethane, chloroform, N,N-dimethylformamide, tetrahydrofuran, acetone, and hexane.

19. An application of the polydimethylsiloxane superamphiphobic coating according to claim 1 in cleaning of a planarization device during a chemical-mechanical planarization process.

20. An application of the polydimethylsiloxane superamphiphobic coating prepared by the preparation method according to claim 10 in cleaning of a planarization device during a chemical-mechanical planarization process.
